(19) United States
(12) Patent Application Publication
(10) Pub. No.: US 2004/0035244 A1
(43) Pub. Date: Feb. 26, 2004

(54) Crankshaft assembly and method for manufacturing same

(76) Inventors: Donald G. Leith, West Bloomfield, MI (US); Jingming Huang, Novi, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/223,754

(22) Filed: Aug. 20, 2002

(51) Int. Cl. F16C 3/04

(52) U.S. Cl. 74/595

(57) ABSTRACT

A crankshaft assembly for use with a connecting rod having a one-piece crankpin bearing support. The crankshaft assembly includes a first one-piece crankshaft portion having a first counterweight, a first end of a main axle extending outwardly from one end of the first counterweight, and a crankpin extending outwardly from the other end of the first counterweight. Similarly, a second one-piece crankshaft portion includes a second counterweight, a second end of the main axle extending outwardly from one end of the second counterweight. The second one-piece crankshaft portion also includes a crankpin receiving hole formed in the second counterweight. The one-piece crankpin bearing support on the connecting rod is positioned over the crankpin and, thereafter, the first and second crankshaft portions are secured together by press fitting the crankpin on the first crankshaft portion into the receiving hole on the second crankshaft portion. A method of manufacturing the crankshaft assembly is also disclosed.

### BACKGROUND OF THE INVENTION

I. Field of the Invention

The present invention relates generally to crankshaft assemblies.

II. Description of Related Art

There are many types of previously known crankshaft assemblies that are used in internal combustion engines and compressors. These crankshaft assemblies typically include an elongated main shaft adapted to rotate about its longitudinal axis. The shaft includes a radially offset crankpin between its ends and this offset portion has an axis parallel to but radially spaced from the axis of rotation of the main shaft. A pair of counterweights are secured to or formed as a part of the shaft so that one counterweight is provided at each end of the crankpin.

An annular bearing support at one end of an elongated connecting rod is then attached to the crankpin. The opposite end of the connecting rod is secured to a piston by a piston pin which reciprocates in the standard fashion upon rotation of the main shaft.

There have been a number of previously known methods for manufacturing these previously known crankshafts. In one prior method, the entire crankshaft together with the counterweights is formed as a one-piece casting and this casting is then machined to form not only the main bearing surfaces for the crankshaft, but also the bearing surface for the crankpin. With this type of crankshaft assembly, in order to connect the connecting rod to the crankpin, the connecting rod bearing support is made of a two-part construction. The first part includes a semi-circular bearing support which is positioned around the crankpin. A semi-circular connecting rod cap is then positioned around the crankpin so that the crankpin is sandwiched in between the connecting rod and the cap. The cap is then secured to the connecting rod by bolts or other fasteners.

These previously known cast crankshafts are advantageous since the entire crankshaft, including the crankpin, main shaft and counterweights, are all of a one-piece construction. As such, these crankshafts exhibit high strength so that failure of the crankshaft through breakage is uncommon. Furthermore, these crankshaft assemblies are advantageous in that, in the event of damage to the connecting rod or its associated components, the connecting rod can be removed and replaced.

There are, however, several disadvantages of these previously known cast crankshafts.

One disadvantage of these previously known cast crankshafts is that the crankshafts are expensive to manufacture. This high manufacturing cost results not only from the cost of the casting operation, but also from expensive and specialized machinery required to form the machined bearing surfaces on both the main shaft and crankpin.

A still further disadvantage of these previously known cast crankshafts is that, since the connecting rod cap is secured to the connecting rod by threaded fasteners, failure of the threaded fasteners and/or loosening of the threaded fasteners can occur. Such failure can damage not only the connecting rod, but also the crankpin on the crankshaft.

There are, however, multi-piece crankshaft assemblies in which the crankpin, counterweights, and main shaft are all formed from separate components. The separate components are then secured together, for example, by press fitting the components together to form the crankshaft assembly. One advantage of these multi-piece crankshafts is that such assemblies may be used in connection with connecting rods having a one-piece crankpin bearing support. As such, failure of the connecting rod by failure of the connecting rod cap fasteners is entirely eliminated.

One disadvantage of these previously known multi-piece crankshaft assemblies, however, is that the overall crankshaft assembly exhibits a much lower strength against torsional forces and the like than the previously known cast and machined crankshafts. In practice, the connection between the various components of the multi-piece crankshaft assembly can become loose and result in failure of the entire crankshaft assembly. Furthermore, a prime area of failure of these previously known multi-piece crankshaft assemblies occurs at the connection between the main shaft and the counterweights, i.e. at the point of maximum torsional forces.

At present, there have been no previously known crankshaft assemblies having a counterweight on each axial end of the crankpin and which utilizes a connecting rod having a one-piece crankpin bearing support able to withstand the high torsional forces between the main shaft and the counterweight.

### SUMMARY OF THE PRESENT INVENTION

The present invention provides a crankshaft assembly which overcomes all of the above-mentioned disadvantages of the previously known crankshaft assemblies.

In brief, the crankshaft assembly of the present invention comprises a first one-piece crankshaft portion which is formed by casting. The first one-piece crankshaft portion includes a first counterweight, a first end of a main axle extending outwardly from one end of the counterweight, and a crankpin extending outwardly from the other end of the first counterweight. Appropriate bearing surfaces are machined in any conventional fashion on both the crankpin as well as the first end of the main axle.

The crankshaft assembly of the present invention further includes a second one-piece crankshaft portion having a second counterweight and a second end of the main shaft extending outwardly from one end of the second counterweight. The second one-piece crankshaft portion is also formed as a casting and the required bearing surface is machined in any conventional fashion on the second end of the main axle. Additionally, a crankpin receiving hole is formed in the second counterweight so that the axis of the crankpin receiving hole is parallel to but spaced from the rotational axis of the main shaft.

During the assembly of the crankshaft assembly of the present invention, a one-piece bearing support of a connecting rod is first positioned over the crankpin. Thereafter, the crankpin is attached to the second crankshaft portion preferably by press fitting the crankpin into the crankpin receiving hole on the second counterweight. Minor final machining is then optionally performed on the second end of the main axle to ensure concentricity of the two portions of the main axle.

Unlike the previously known multi-piece crankshaft assemblies, the crankshaft assembly of the present invention is able to withstand the high torsional forces between the main axle and the counterweights due to the one-piece construction of each counterweight with its associated end of the main axle. However, since the crankshaft is still formed as a multi-piece assembly, connecting rods having a one-piece crankpin bearing support may be used with the crankpin assembly of the present invention.

A method of manufacturing the crankshaft assembly of the present invention is also disclosed.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a side view illustrating a preferred embodiment of the crankshaft assembly of the present invention;

FIG. 2 is a longitudinal sectional view illustrating the preferred embodiment of the present invention;

FIG. 3 is a view taken substantially along line 3-3 in FIG. 2;

FIG. 4 is an end view taken substantially along line 4-4 in FIG. 2; and

FIG. 5 is an exploded perspective view of the preferred embodiment of the present invention.

### DETAILED DESCRIPTION OF A PREFERRED EMBODIMENT OF THE PRESENT INVENTION

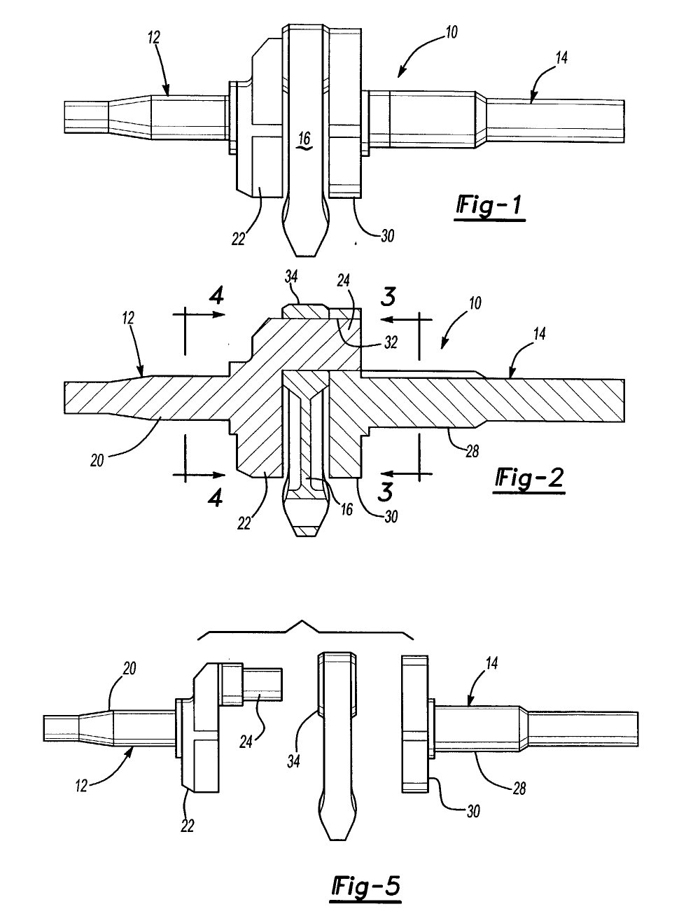

With reference first to FIGS. 1 and 2, a preferred embodiment of the crankshaft assembly 10 of the present invention is shown for use with an internal combustion engine, compressor or the like. The crankshaft assembly 10 includes both a first one-piece crankshaft portion 12 and a second one-piece crankshaft portion 14 as well as a connecting rod 16.

With reference now to FIGS. 2 and 5, the first one-piece crankshaft portion 12 includes both a first end 20 of a main shaft, a first counterweight 22 and a crankpin 24. The entire first one-piece crankshaft portion 12 is formed by casting from any appropriate material, such as an iron-based metal.

After the first crankshaft portion 12 is formed by casting, the outer bearing surfaces on both the crankpin 24 as well as the first end 20 of the main shaft are machined in any conventional fashion. Furthermore, the axis of the crankpin 24 is parallel to but radially spaced from the axis of the first end 20 of the main shaft.

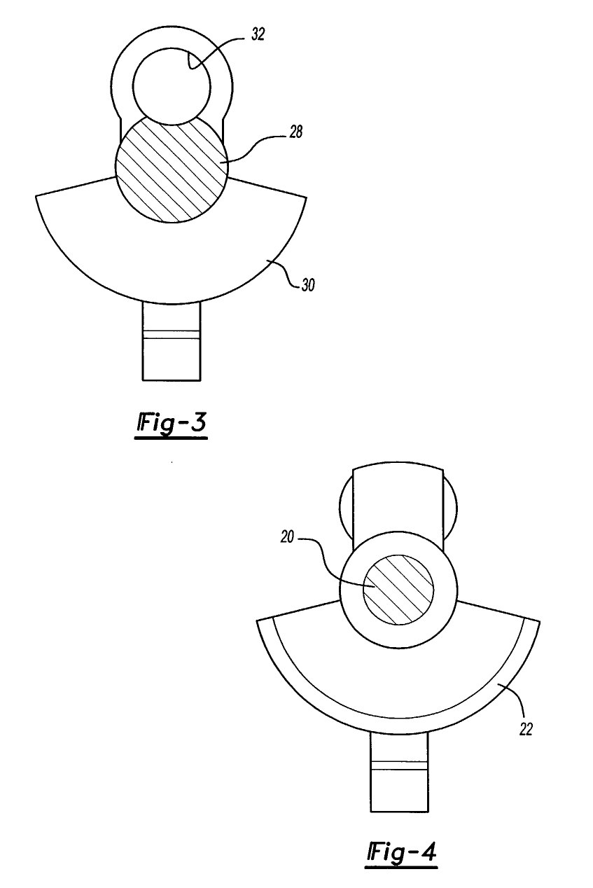

Referring to FIGS. 2-5, the second one-piece crankshaft portion 14 is also formed by casting an appropriate metal, such as a steel-based metal. The second crankshaft portion 14 includes a second end 28 of the main shaft as well as a second counterweight 30.

Any conventional method is utilized to machine the outer surface of the second end 28 of the main shaft to form the required bearing surfaces. Additionally, a crankpin receiving hole 32 is machined through the counterweight 30 so that the axis of the hole 32 is parallel to, but radially spaced from, the axis of the second end 28 of the main shaft. The diameter of the crankpin receiving hole 32 is preferably slightly less than the outside diameter of the crankpin 24. Although the crankpin receiving hole 32 is preferably circular in cross-sectional shape, it may optionally be noncircular to confirm with a noncircular end of the crankpin 24.

After the ends 20 and 28 of the main axle are machined to form the required bearing surfaces as well as the bearing surface on the crankpin 24, the crankshaft assembly is ready for assembly. The crankshaft assembly 10 is most advantageously used with a connecting rod 16 having a one-piece bearing support 34. Thus, in order to secure the bearing support 34 to the assembly 10, the bearing support 34 is positioned over the crankpin 24 prior to the attachment of the first crankshaft portion 12 to the second crankshaft portion 14.

After the bearing support 34 is positioned over the crankpin 24, the crankshaft portions 12 and 14 are coaxially aligned. Thereafter, the crankpin 24 is attached within the crankpin receiving hole 32 on the second counterweight 30. Preferably, the attachment between the crankpin 24 and the second counterweight 30 is by a press fit, although any other conventional means, such as an adhesive, may alternatively be used.

Although the concentricity of the ends 20 and 28 of the main shaft can usually be maintained during the attachment operation of the crankpin 24 to the counterweight 30, if necessary, final machining of either the first crankshaft portion 12, second crankshaft portion 14, or both, may be deferred until the first and second crankshaft portions 12 and 14, respectively, are secured together.

From the foregoing, it can be seen that the present invention provides a crankshaft assembly capable of utilizing a connecting rod having a one-piece crankpin bearing support and which enjoys torsional strength between the main shaft and the counterweights. Having described my invention, however, many modifications thereto will become apparent to those skilled in the art to which it pertains without deviation from the spirit of the invention as defined by the scope of the appended claims.

I claim:

1. A method for manufacturing a crankshaft assembly with an attached connecting rod having a one-piece crankpin bearing support comprising the steps of:
casting a first one-piece crankshaft portion from a metal, said first one-piece crankshaft portion having a first counterweight,
casting a second one-piece crankshaft portion from a metal, said second one-piece crankshaft portion having a second counterweight,
machining one end of a main shaft and a crankpin on said first one-piece crankshaft portion on opposite sides of said first counterweight, said one end of said main shaft and said crankpin having longitudinal axes which are spaced apart and parallel to each other,
machining a second end of the main shaft and a crankpin receiving hole in said second counterweight on said second one-piece shaft portion,
sliding the one-piece crankpin bearing support over said crankpin, and
thereafter attaching said crankpin in said crankpin receiving hole.

2. The invention as defined in claim 1 wherein said attaching step comprises press fitting said crankpin into said crankpin receiving hole.

3. The invention as defined in claim 1 and comprising the step of further machining said second end of said main shaft subsequent to said attaching step.

4. A crankshaft assembly comprising:
a first one-piece crankshaft portion having a first counterweight, a first end of a main axle extending outwardly from one end of said first counterweight and a crankpin extending outwardly from the other end of said first counterweight,
a second one-piece crankshaft portion having a second counterweight, a second end of said main axle extending outwardly from one end of said second counterweight and a crankpin receiving hole formed in said second counterweight, said crankpin receiving hole having an axis parallel to, but radially spaced from, an axis of said second end of said main axle,
a connecting rod having a one-piece crankpin bearing support, said crankpin bearing support being positioned around said crankpin,
said crankpin being secured to said second one-piece crankshaft portion within said crankpin receiving hole so that said crankpin bearing support is sandwiched between said first and second counterweights.

5. The invention as defined in claim 4 wherein said crankpin is press fit into said crankpin receiving hole.
